(19) United States
(12) Patent Application Publication
(10) Pub. No.: US 2013/0250297 A1
(43) Pub. Date: Sep. 26, 2013

(54) INSPECTION APPARATUS AND INSPECTION SYSTEM

(71) Applicants: Masaaki Ito, Hitachinaka (JP); Minori Noguchi, Joso (JP)

(72) Inventors: Masaaki Ito, Hitachinaka (JP); Minori Noguchi, Joso (JP)

(73) Assignee: Hitachi High-Technologies Corporation, Tokyo (JP)

(21) Appl. No.: 13/990,103

(22) PCT Filed: Oct. 11, 2011
(86) PCT No.: PCT/JP2011/005673

§ 371 Date: May 29, 2013

(30) Foreign Application Priority Data
Nov. 30, 2010 (JP) 2010-265896

(51) Int. Cl. G01N 21/95

(52) U.S. Cl. CPC G01N 21/9501
USPC 356/369; 356/237.5

(57) ABSTRACT

Disclosed here is a macro inspection apparatus for a sample such as a semiconductor wafer having a pattern formed thereon, the apparatus being capable of detecting abnormalities in dimension and size with high sensitivity.

The inspection apparatus for a sample having pattern formed thereon includes: an illumination optical system which illuminates the sample having the pattern formed thereon; a detection optical system which receives scattered light from the pattern; an imaging device which is disposed over a pupil plane of the detection optical system, the imaging device acquiring Fourier images of the pattern; and a processing unit which compares the Fourier images with the Fourier image of the normal pattern to detect an irregularity of the pattern.

### TECHNICAL FIELD

The present invention relates to an inspection apparatus and an inspection system for a sample having a pattern formed thereon such as a wafer in the production of semiconductor devices.

For example, this invention relates to a so-called macro inspection apparatus and macro inspection method.

### BACKGROUND ART

In the production of semiconductor devices, the formation of a pattern using lithography and etching is repeated a large number of times. Lithography is a technique whereby a resist is applied to the wafer and a photo mask image is transferred to the resist using an exposure apparatus before the resist is developed to form the pattern.

Etching is a technique whereby the foundation film such as a metal film or an oxide film is selectively removed using the resist pattern as the mask.

In the formation of a pattern, it is necessary precisely to manage the dimension (so-called critical dimension) and shape (side wall angles and heights) of the pattern.

The major causes of pattern irregularities are focal position shifts and exposure amount variances in the exposure apparatus, and inconsistencies of reactant gas concentration in the etching apparatus.

In many cases, the pattern irregularities due to these causes occur over a region of between tens of μm and hundreds of μm.

In order to monitor whether the exposure apparatus and etching apparatus are normally operating, the so-called macro inspection apparatus for inspecting pattern irregularities over the entire region of between tens of μm and hundreds of μm is utilized.

Because of its low spatial resolution, the macro inspection apparatus cannot observe individual patterns.

However, with its high throughput, the macro inspection apparatus has the advantage of inspecting the whole surfaces of the total number of wafers flowing through the production line.

Regarding conventional macro inspection apparatuses, JP-11-72443-A (Patent Document 1) is known, for example. According to Patent Document 1, parallel light is illuminated on the entire wafer surface. Refracted light or scattered light from the pattern is received and a wafer image is formed on an imaging plane. The acquired image is compared with a normal wafer image to detect pattern irregularities. By varying the wavelength of illuminating light, refracted light can be received in a manner addressing various pattern cycles.

Also, regarding the inspection apparatus for foreign matters such as those of a photo mask, JP-6-94630-A (Patent Document 2) is known, for example. According to Patent Document 2, a spot beam is illuminated on the surface under test and an image on the pupil plane of a receiver lens is acquired. The diffracted light from the pattern is distinguished from the scattered light from foreign matters to detect whether foreign matters exist.

Other prior art is described in Patent Document 3 and Patent Document 4.

### PRIOR ART DOCUMENTS

### Patent Document

Patent Document 1: JP-11-72443-A
Patent Document 2: JP-6-94630-A
Patent Document 3: JP-2008-116405-A
Patent Document 4: JP-6-094633-A

### SUMMARY OF THE INVENTION

### Problem to be Solved by the Invention

With semiconductor devices increasingly miniaturized in structure, the macro inspection device is called on to improve its sensitivity to detect pattern irregularities.

However, when the repeat pattern cycle is less than half the wavelength of light, refracted light does not occur in principle. Given such reductions of the pattern cycle, it is indispensable to shorten the wavelength if refracted light is to be received using prior art.

For example, if the pattern cycle is 80 nm, the wavelength of light needs to be about 150 nm. However, refractive lenses cannot be used in such a vacuum ultraviolet region, which makes it difficult to design and manufacture an optical system. Furthermore, the need to use a vacuum optical path complicates the configuration of the system.

On the other hand, even with wavelengths on which refracted light does not occur, scattered light is generated typically due to pattern edge roughness. Unlike refracted light, scattered light has the characteristic of dispersing over a wide angular range. According to Patent Document 1, however, the intensity distribution of scattered light is not sufficiently taken into account, which makes it difficult to further improve the sensitivity of detection.

Meanwhile, Patent Document 2 takes into account the intensity distribution of the refracted light from the pattern and from foreign matters. However, the object to be detected is foreign matters, and there is no consideration for how to detect pattern irregularities.

An object of the present invention is to provide a macro inspection apparatus capable of detecting pattern irregularities highly sensitively on semiconductor devices increasingly miniaturized in structure.

### Means for Solving the Problem

The present invention has the following features for example:

According to the present invention, there is provided an inspection apparatus for a sample having a pattern formed thereon. The inspection apparatus includes: an illumination optical system which illuminates the sample having the pattern formed thereon; a detection optical system which receives scattered light from the pattern; an imaging device which is disposed over a pupil plane of the detection optical system, the imaging device acquiring Fourier images of the pattern; and a processing unit which compares the Fourier image with the Fourier image of the normal pattern to detect an irregularity of the pattern.

According to this invention, the illumination optical system may illuminate the sample with predetermined polarized light, and the imaging device may acquire the Fourier images of the pattern with a predetermined polarized component of the scattered light.

According to this invention, there may be included a polarizing filter disposed in front of the imaging device.

According to this invention, the imaging device may have a photonic crystal element per pixel, and the polarizing axes of adjacent pixels may be oriented differently from one another.

According to this invention, the imaging device may acquire Fourier images of the pattern using differently polarized components of the scattered light, and the processing unit may compare the Fourier images with the Fourier image of the normal pattern.

According to this invention, the processing unit may divide the Fourier images of the pattern and the Fourier image of the normal pattern into portions to make a comparison regarding each portion.

According to this invention, the Fourier image of the normal pattern may be stored in the apparatus.

According to this invention, the processing unit may separate the Fourier images into an orthogonal Nicol image and a parallel Nicol image.

According to this invention, the processing unit may perform at least one of the comparisons between the parallel Nicol image and a parallel Nicol image of the normal pattern and between the orthogonal Nicol image and an orthogonal Nicol image of the normal pattern.

According to this invention, the processing unit may perform a logical OR operation on the result of the comparison between the parallel Nicol image and the parallel Nicol image of the normal pattern and on the result of the comparison between the orthogonal Nicol image and the orthogonal image of the normal pattern.

According to the present invention, there is provided an inspection apparatus for a sample having a pattern formed thereon. The inspection apparatus includes: an illumination optical system which illuminates the sample having the pattern formed thereon; a plurality of light-receiving systems which receive scattered light from the pattern in a plurality of directions; and a processing unit which compares the intensity distribution of the scattered light with the intensity distribution of scattered light of the normal pattern so as to detect an irregularity of the pattern.

According to this invention, the illumination optical system may illuminate the sample with predetermined polarized light, and the light-receiving systems may receive predetermined polarized components of the scattered light from the pattern.

According to this invention, the intensity distribution of scattered light of the normal pattern may be stored in the apparatus.

According to the present invention, there is provided an inspection system for a sample having a pattern formed thereon. The inspection system includes a first inspection apparatus and a second inspection apparatus. The first inspection apparatus includes: an illumination optical system which illuminates the sample having the pattern formed thereon; a detection optical system which receives scattered light from the pattern; an imaging device which is disposed over a pupil plane of the detection optical system, the imaging device acquiring Fourier images of the pattern; and a processing unit which compares the Fourier images with the Fourier image of the normal pattern to detect the position of an irregularity of the pattern. The second inspection apparatus receives position coordinates of the irregularity from the first inspection apparatus to observe the position and has a higher resolution than the inspection apparatus.

According to the present invention, there is provided an inspection system for a sample having a pattern formed thereon. The inspection system includes a first inspection apparatus and a second inspection apparatus. The first inspection apparatus includes: an illumination optical system which, illuminates the sample having the pattern formed thereon; a plurality of light-receiving systems which receive scattered light from the pattern in a plurality of directions; and a processing unit which compares the intensity distribution of the scattered light with the intensity distribution of scattered light of the normal pattern so as to detect an irregularity of the pattern. The second inspection apparatus receives position coordinates of the irregularity from the first inspection apparatus to observe the position and has a higher resolution than the inspection apparatus.

### Effects of the Invention

According to this invention, pattern irregularities may be detected with high sensitivity.

### BRIEF DESCRIPTION OF THE DRAWINGS

FIG. 1 shows a first embodiment of an inspection apparatus according to the present invention.

FIG. 2 shows how a Fourier image is formed.

FIG. 3 shows a cross section of a wafer during inspection of a lithography process.

FIG. 4 shows intensity changes of a Fourier image per portion thereof in keeping with pattern dimension changes.

FIG. 5 shows a second embodiment of an inspection apparatus according to the present invention.

FIG. 6 shows a structure of a polarization imaging device.

FIG. 7 shows relations between the azimuth angles of illuminating light on the one hand and the transmission axes of a polarization imaging device on the other hand.

FIG. 8 shows choices of pixels in the polarization imaging device for polarization detection.

FIG. 9 shows a method for processing Fourier images acquired by the polarization imaging device.

FIG. 10 shows a third embodiment of an inspection apparatus according to the present invention.

### MODE FOR CARRYING OUT THE INVENTION

Some execution examples of the present invention are explained below in reference the accompanying drawings.

### Execution Example 1

Explained below as the first embodiment of the present invention (called the execution example 1 hereunder) is an inspection apparatus targeted for wafers in the production of semiconductor devices.

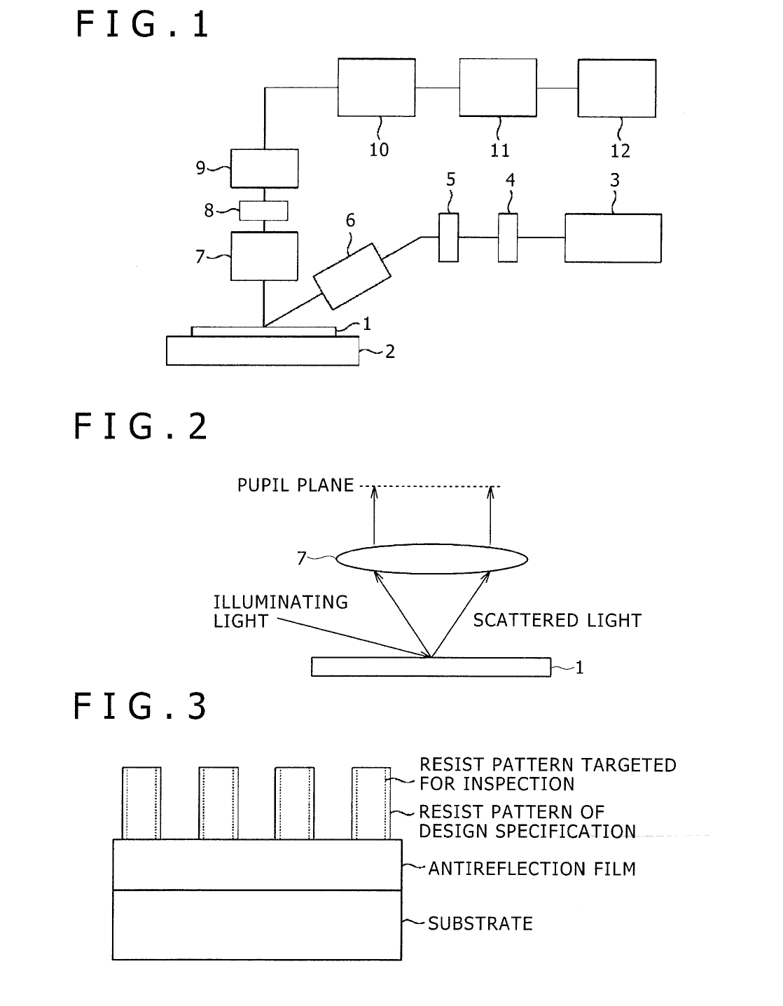

FIG. 1 shows an overall structure of an inspection apparatus practiced as this execution example. The inspection apparatus of this execution example includes a stage 2 that supports a wafer 1, a discharge light source 3, a wavelength filter 4, a first polarizing filter 5, an illumination optical system 6, a detection optical system 7, a second polarizing filter 8, an imaging device 9, an image processing system 10, a control system 11, and an operation system 12.

The discharge light source 3 emits multiwavelength light or wideband light. The wavelength filter 4 transmits light of a predetermined wavelength, and the first polarizing filter 5 turns the transmitted light into linearly polarized light. The illumination optical system 6 converts the linearly polarized light into parallel light that illuminates the wafer 1 at a predetermined incidence angle and azimuth angle. The size of an illuminated area is set in accordance with required spatial resolution.

The illumination from the illumination optical system 6 causes the pattern of the illuminated area (called the inspection pattern hereunder) to emit scattered light.

The detection optical system 7 is a Fourier transform optical system which, as shown in FIG. 2, receives scattered light to form a Fourier image over its pupil plane. Specularly reflected light is emitted outside the pupil plane and does not contribute to forming a Fourier image. Refracted light may enter the pupil plane depending on the inspection pattern cycle, but poses little problem. The second polarizing filter 8 transmits a predetermined linearly polarized light component of the scattered light to let the imaging device disposed over the pupil plane acquire a Fourier image. A CCD (charge-coupled device) image sensor, a CMOS image sensor or the like may be used as the imaging device 9.

In the execution example 1, the relative angle between the transmission axis of the first polarizing filter 5 and that of the second polarizing filter 8 may be varied to acquire an image of a polarized component perpendicular to the polarization direction of illuminating light (orthogonal Nicol) or parallel therewith (parallel Nicol). That is, the inspection apparatus of the execution example 1 is structured to vary the relative angle between the transmission axis of the first polarizing filter 5 and that of the second polarizing filter 8.

Also, it is possible to remove the second polarizing filter 8 from the optical path so that Fourier images may be acquired regardless of polarization. That is, in the inspection apparatus of the execution example 1, the second polarizing filter may be controlled to be removed from and placed back into the optical path.

Next, the Fourier image of the detected inspection pattern is converted to a digital signal that is sent to the image processing system 10. The image processing system 10 stores Fourier images of the normal pattern under the above-mentioned optical conditions. In this context, the normal pattern refers to a set of patterns of which the deviations in dimensions and shape from the design specification pattern fall within a tolerable range.

The Fourier image of the inspection pattern is compared with the Fourier images of the normal pattern to detect an irregularity of the inspection pattern. More specifically, a pattern irregularity is detected by determining whether the deviations of the inspection pattern from the pattern of reference exceed predetermined values. If an irregularity of the inspection pattern is detected, position coordinates of the irregularity are sent to the control system 11.

The stage is then scanned in a manner inspecting the entire surface of the wafer. Finally, the position of the irregular pattern is displayed on the operation system 12.

The discharge light source 3 of the above execution example is a mercury lamp, a Xenon lamp or the like. If the illuminating light is allowed to have a fixed wavelength, a solid-state light source such as a laser or a light-emitting diode may be used in the visible light region, in the ultraviolet region, or in the far-ultraviolet region. In such a case, there is no need for a wavelength filter.

Also, a refraction type optical system composed of lenses, a reflection type optical system composed of mirrors, a reflection/refraction type optical system combining mirrors with lenses, a diffraction type optical system such as a Fresnel zone plate or the like may be used as the detection optical system 7 of the above execution example.

Fourier images of the normal pattern may be acquired using test wafers. The test wafer is a wafer into which various dimensions and sizes are built by changing the focal position and exposure amount per exposed region with, say, an exposure apparatus transferring photo mask patterns to the wafer. Also, Fourier images of the normal pattern may be acquired through numerical simulations. Highly precise predictions are possible using the finite difference time domain method or rigorous coupled wave analysis, with the shape/dimensions and refraction index of the pattern and the optical conditions of the inspect apparatus taken as the input data.

Explained next is how the inspection apparatus of the execution example 1 is structured to improve its sensitivity to detect pattern irregularities.

FIG. 3 shows a cross section of a wafer under inspection following resist development in the lithography process. The resist pattern targeted for inspection is 7 percent smaller in dimensions than the design specification.

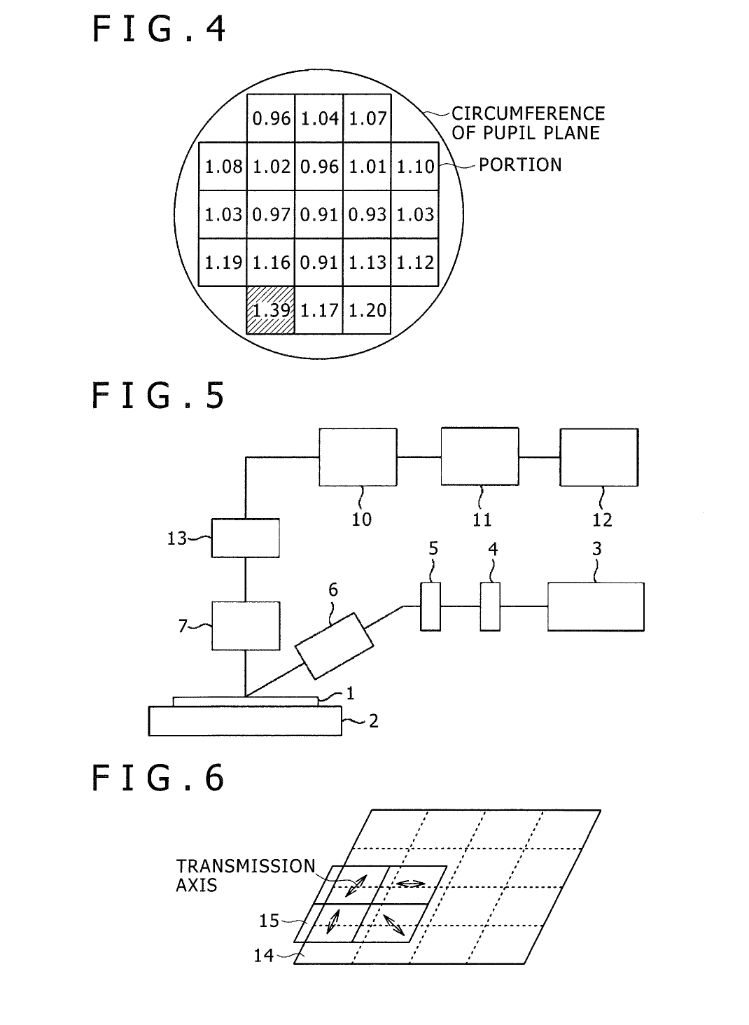

FIG. 4 shows a pupil plane divided into 21 portions each having a Fourier image of the inspection pattern and that of the design specification pattern averaged in intensity so as to acquire the ratio therebetween. The averaging is carried out in portions so that stable output may be obtained.

Incidentally, the number of divided portions may be set as needed by the image processing system 10. That is, the image processing system 10 can change the number of divided portions over the pupil plane.

According to prior art whereby the pattern is imaged on the imaging plane, the resulting signal is equivalent to the average of the intensities of all Fourier images. Thus the change rate of the signal with regard to dimensional variability is 7 percent.

Meanwhile, with the execution example 1, the signal denotes the intensity of the Fourier image per portion. Thus the change rate of the signal with regard to dimensional variability is up to 39 percent (shaded portion). Comparing the Fourier images in this manner turns out to make the sensitivity of detection higher than if prior art is resorted to.

### Execution Example 2

FIG. 5 shows the second embodiment of the present invention (called the execution example 2 hereunder). The structures of the execution example 2 that are the same as those of the execution example 1 will not be discussed further.

The execution example 2 uses a polarization imaging device 13 in place of the polarizing filter and imaging device of the execution example 1.

The polarization imaging device 13 has a photonic crystal element 15 disposed per pixel of the imaging device, as shown in FIG. 6. The polarization imaging device 13 is composed of four contiguous pixels making up a single set. The transmission axes of these pixels are oriented 45 degrees apart.

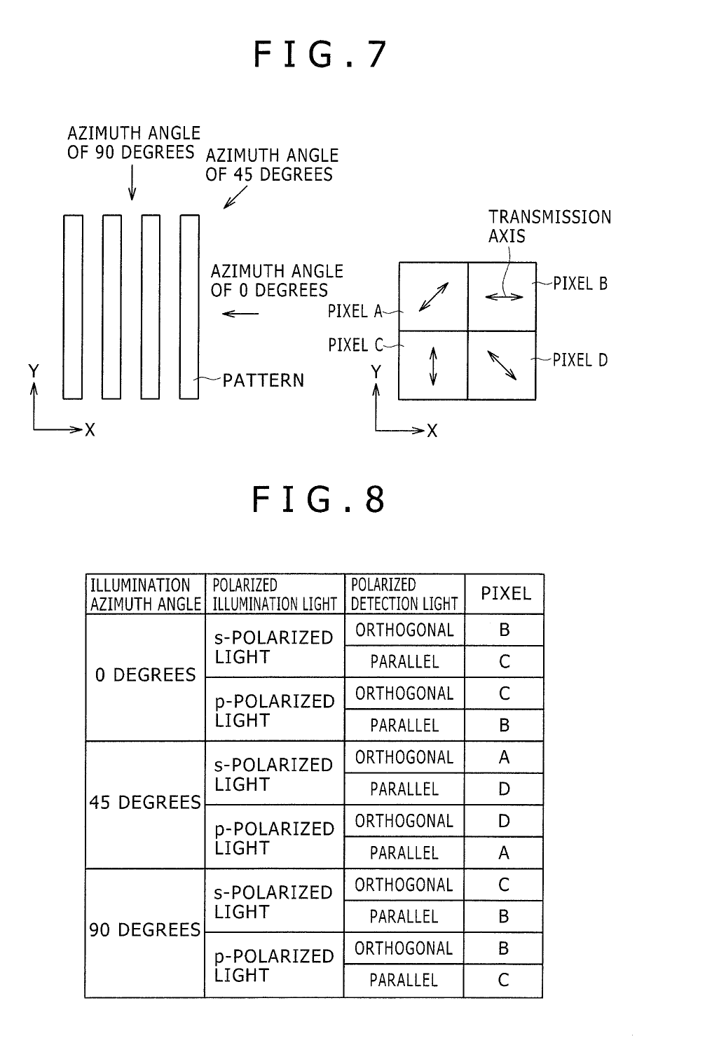

FIG. 7 shows relations between the azimuth angles of illuminating light with regard to a pattern on the one hand (i.e., angles inside the wafer surface) and the transmission axes of the polarization imaging device on the other hand.

As shown in FIG. 8, the execution example 2 may get one pixel to detect a polarized light component perpendicular to s-polarized or p-polarized illuminating light (orthogonal Nicol) and another pixel to detect a light component that is parallel therewith (parallel Nicol) even when the azimuth angle of illuminating light with regard to a pattern is any one of 0, 45, and 90 degrees. The execution example 2 may also have the remaining two pixels detecting a polarized light component at an angle of 45 degrees relative to the polarization direction of the illuminating light.

In this manner, the execution example 2 allows the polarization imaging device 13 simultaneously to acquire images of polarized components that are different from one another.

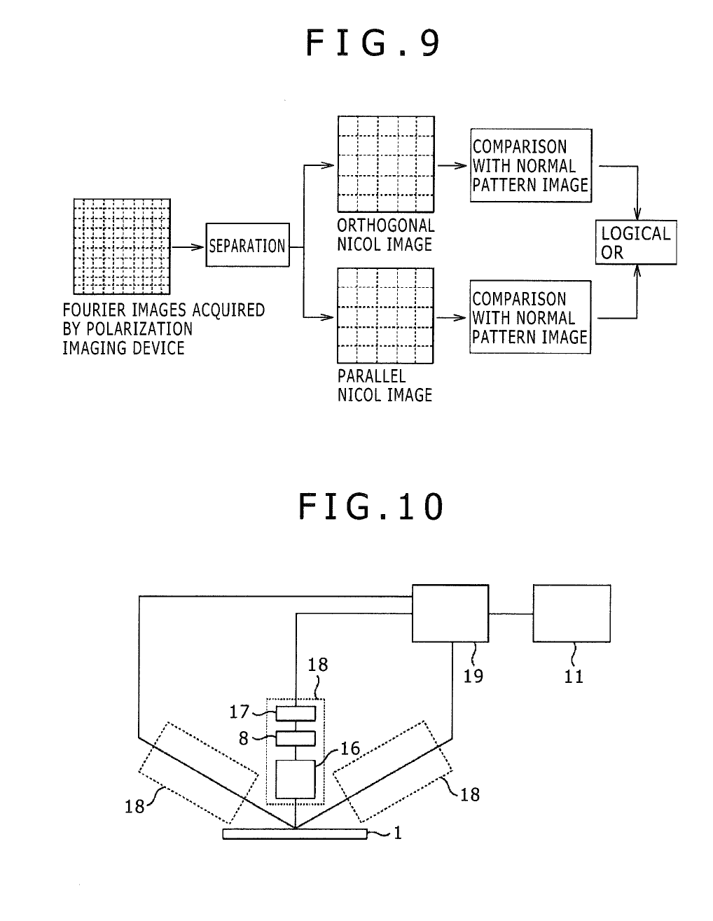

Next, FIG. 9 shows a method for processing Fourier images acquired by the polarization imaging device 13.

The pixels of predetermined polarizing axes are selected from an acquired image in such a manner that an orthogonal Nicol image and a parallel Nicol image are separated. Although the resolution of the separated images is half that of the acquired image, there is no problem in comparing Fourier images. An irregularity may be detected by comparing the orthogonal Nicol image of the inspection pattern with the orthogonal Nicol image of the normal pattern.

An irregularity may also be detected by comparing the parallel Nicol image of the inspection pattern with the parallel Nicol image of the normal pattern. A logical OR operation is performed on the results of the two comparisons to determine an irregularity of the inspection pattern. If an irregularity is detected in the inspection pattern, the position coordinates of the irregularity are sent to the control system.

As opposed to the execution example 1, the execution example 2 compares the inspection pattern with the normal pattern under a plurality of optical conditions. This allows the execution example 2 to lower the probability of overlooking irregularities. With the results of comparisons analyzed under multiple optical conditions, it is also easy for the execution example 2 to identify irregularities in dimensions and shape.

### Execution Example 3

FIG. 10 shows the third embodiment of the present invention (called the execution example 3 hereunder). The structure upstream of the illumination optical system is the same as that of the first embodiment and thus is omitted from the drawing.

The execution example 3 has a plurality of light-receiving systems 18 disposed at predetermined elevation and azimuth angles, each system being composed of a light-condensing optical system 16, a second polarizing filter 8, and a photo detection device 17.

With the execution example 3, the wafer is illuminated at predetermined incidence and azimuth angles using predetermined linearly polarized light. The inspection pattern emits scattered light. Predetermined polarized components of the scattered light are detected by the respective light-receiving systems and sent thereby to a signal processing system 19.

The signal processing system 19 prepares intensity distribution of the scattered light from the inspection pattern based on light reception signals from the multiple light-receiving systems. The signal processing system 19 stores the intensity distribution of scattered light from the normal pattern under the above-mentioned optical conditions. A comparison is made between the intensity distribution of the scattered light from the inspection pattern and the intensity distribution of scattered light from the normal pattern so as to detect an irregularity of the inspection pattern. If an irregularity of the inspection pattern is detected, the position coordinates of the irregularity are sent to the control system.

Compared with the execution example 1, the execution example 3 can use photomultipliers that are more sensitive than such imaging devices as the CCD image sensor. For this reason, the execution example 3 is more advantageous in detecting very feeble scattered light. Another advantage is that with a high degree of freedom in the spatial layout of the light-receiving systems, it is possible for the execution example 3 to receive scattered light at low elevation angles.

As explained above, the inspection apparatus of the present invention can detect pattern irregularities of a macro region with high sensitivity over the entire surface of all wafers moving through the production line.

Also, a wafer having an irregularity detected by the inspection apparatus of the execution examples 1 through 3 (first inspection apparatus) may be transported to an electron beam inspection apparatus (or an optical inspection apparatus if it has high enough resolution) having an electron optical system with a higher resolution than the optical system of the inspection apparatus constituting the execution examples 1 through 3. Since the position of the irregularity is already identified, the electron beam inspection apparatus can observe the irregular pattern in detail.

The method above involves getting the macro inspection apparatus to detect the position of an irregularity, receiving information about that position (coordinates within the wafer and coordinates inside the chip), and getting the electron beam inspection apparatus to observe the position in question. As such, the method is effective in improving fabrication yield while lowering inspection costs.

Whereas the inspection apparatus of the present invention has been described above in connection with the wafer during production of semiconductor devices, the inventive inspection apparatus can also be applied extensively to inspecting other samples with patterns formed thereon, such as those of magnetic storage media and liquid crystal devices.

### DESCRIPTION OF REFERENCE NUMERALS

1 Wafer
2 Stage
3 Discharge light source
4 Wavelength filter
5 First polarizing filter
6 Illumination optical system
7 Detection optical system
8 Second polarizing filter
9 Imaging device
10 Image processing system
11 Control system
12 Operation system
13 Polarization imaging device
14 Pixels
15 Photonic crystal element
16 Light-condensing optical system
17 Photo detection device
18 Light-receiving system
19 Signal processing system

1. An inspection apparatus for a sample having a pattern formed thereon, said inspection apparatus comprising:
an illumination optical system which illuminates said sample having said pattern formed thereon;
a detection optical system which receives scattered light from said pattern;
an imaging device which is disposed over a pupil plane of said detection optical system, the imaging device acquiring Fourier images of said pattern; and
a processing unit which compares an average of said Fourier images with the Fourier image of the normal pattern to detect an irregularity of said pattern.

2. The inspection apparatus according to claim 1, wherein said illumination optical system illuminates said sample with predetermined polarized light, and
wherein said imaging device acquires the Fourier images of said pattern with a predetermined polarized component of the scattered light.

3. The inspection apparatus according to claim 2, further comprising a polarizing filter disposed in front of said imaging device.

4. The inspection apparatus according to claim 2, wherein said imaging device has a photonic crystal element per pixel, and
wherein the polarizing axes of adjacent pixels are oriented differently from one another.

5. The inspection apparatus according to claim 4, wherein said imaging device acquires Fourier images of said pattern using differently polarized components of the scattered light, and
wherein said processing unit compares said Fourier images with the Fourier image of the normal pattern.

6. The inspection apparatus according to claim 1, wherein said processing unit divides the Fourier images of said pattern and the Fourier image of the normal pattern into portions to make a comparison regarding each portion.

7. The inspection apparatus according to claim 1, wherein the Fourier image of the normal pattern is stored therein.

8. The inspection apparatus according to claim 5, wherein said processing unit separates said Fourier images into an orthogonal Nicol image and a parallel Nicol image.

9. The inspection apparatus according to claim 8, wherein said processing unit performs at least one of the comparisons between said parallel Nicol image and a parallel Nicol image of the normal pattern and between said orthogonal Nicol image and an orthogonal Nicol image of the normal pattern.

10. The inspection apparatus according to claim 9, wherein said processing unit performs a logical OR operation on the result of the comparison between said parallel Nicol image and the parallel Nicol image of the normal pattern and on the result of the comparison between said orthogonal Nicol image and the orthogonal image of the normal pattern.

11. An inspection apparatus for a sample having a pattern formed thereon, said inspection apparatus comprising:
an illumination optical system which illuminates said sample having said pattern formed thereon;
a plurality of light-receiving systems which receive scattered light from said pattern in a plurality of directions; and
a processing unit which compares an average of intensity distributions of said scattered light with the intensity distribution of scattered light of the normal pattern so as to detect an irregularity of said pattern.

12. The inspection apparatus according to claim 11, wherein said illumination optical system illuminates said sample with predetermined polarized light, and
wherein said light-receiving systems receive predetermined polarized components of the scattered light from said pattern.

13. The inspection apparatus according to claim 11, wherein the intensity distribution of scattered light of the normal pattern is stored therein.

14. An inspection system for a sample having a pattern formed thereon, said inspection system comprising a first inspection apparatus and a second inspection apparatus;
wherein said first inspection apparatus includes:
an illumination optical system which illuminates said sample having said pattern formed thereon;
a detection optical system which receives scattered light from said pattern;
an imaging device which is disposed over a pupil plane of said detection optical system and which acquires Fourier images of said pattern; and
a processing unit which compares an average of said Fourier images with the Fourier image of the normal pattern to detect the position of an irregularity of said pattern, and
wherein said second inspection apparatus receives position coordinates of said irregularity from said first inspection apparatus to observe said position and has a higher resolution than said inspection apparatus.

15. An inspection system for a sample having a pattern formed thereon, said inspection system comprising a first inspection apparatus and a second inspection apparatus;
wherein said first inspection apparatus includes:
an illumination optical system which illuminates said sample having said pattern formed thereon;
a plurality of light-receiving systems which receive scattered light from said pattern in a plurality of directions; and
a processing unit which compares an average of intensity distributions of said scattered light with the intensity distribution of scattered light of the normal pattern so as to detect an irregularity of said pattern, and
wherein said second inspection apparatus receives position coordinates of said irregularity from said first inspection apparatus to observe said position and has a higher resolution than said inspection apparatus.
